(19) United States
(12) Patent Application Publication
(10) Pub. No.: US 2026/0202063 A1
(43) Pub. Date: Jul. 16, 2026

(54) A COOKING DEVICE HAVING AN INTAKE SYSTEM

(71) Applicant: LOCO-CRAZY GOOD COOKERS, INC., Columbus, GA (US)

(72) Inventors: Blake LEVIEN, Katy, TX (US); Joseph MAIORANA, Katy, TX (US); Qin QINGKUN, Panyu (CN); Joseph London Turner, Butler, GA (US)

(21) Appl. No.: 19/138,706

(22) PCT Filed: Dec. 16, 2022
(86) PCT No.: PCT/CN2022/139463

§ 371 Date: Jun. 13, 2025

(51) Int. Cl. F24B 5/08; A47J 36/32; A47J 37/07; F23N 5/00; F24B 1/20

(52) U.S. Cl. CPC F24B 5/087; A47J 36/32; A47J 37/0718; F23N 5/006; F24B 1/207; F23N 2225/16

(57) ABSTRACT

A cooking device, system, and method for operating a cooking device are provided. The cooking device includes: a body having an interior space for holding flammable material; a lid (118) configured to be placed over the body; an intake system (102); and a control system (104) configured to receive an input and output an activation signal to the intake system (102) based on the input, and the intake system (102) being configured to provide air to the interior space in response to the activation signal.

### BACKGROUND

Charcoal grills are widely used to grill different types of foods, such as steaks or burgers, outdoors. One type of charcoal grill is a kettle grill. Kettle grills have a tapered shape, allowing for the placement of a deep bed of briquets to hold in heat. Some kettle grills have an ash holder below the kettle with an opening on the bottom surface of the kettle to allow ashes to drop in the ash holder. A kettle grill may also include a lid that can be closed to prevent heat from escaping and increasing the temperature inside the grill.

### BRIEF SUMMARY

The presently disclosed technology addresses the foregoing problems by providing systems, devices, and methods for operating a cooking device.

The aspects described herein relate to a cooking device including: a body having an interior space for holding flammable material; a lid configured to be placed over the body; an intake system; and a control system configured to receive an input and output an activation signal to the intake system based on the input, the intake system being configured to provide air to the interior space in response to the activation signal.

In some aspects, the techniques described herein relate to a method for operating a cooking device, including: receiving an input indicating to activate an intake system of the cooking device, the cooking device including a body having an interior space for holding flammable material; and providing air to the interior space by activating the intake system in response to the input, wherein the cooking device further includes a lid configured to be placed over the body.

In some aspects, the present disclosure relates to a cooking device including: a body having an interior space for holding flammable material; a lid configured to be placed over the body; and an intake system configured to provide air to the interior space in response to an activation signal and while the lid is closed.

### BRIEF DESCRIPTION OF THE DRAWINGS

FIGS. 1A and 1B illustrate different perspectives of an example kettle grill including an air intake system, in accordance with certain aspects of the present disclosure.

FIGS. 2A and 2B illustrate a fan of an air intake system, in accordance with certain aspects of the present disclosure.

FIG. 3 illustrates a fire bowl, in accordance with certain aspects of the present disclosure.

FIG. 4 illustrates a kettle grill with a cart, in accordance with certain aspects of the present disclosure.

FIG. 5A is a perspective view of a latch handle, in accordance with certain aspects of the present disclosure.

FIG. 5B is a front view of a latch handle, in accordance with certain aspects of the present disclosure.

FIG. 5C is a side view of a latch handle, in accordance with certain aspects of the present disclosure.

FIG. 5D is a side view of a latch handle showing hooks, in accordance with certain aspects of the present disclosure.

FIG. 6 illustrates a method for operating a cooking device, in accordance with certain aspects of the present disclosure.

FIG. 7 illustrates an architecture of a computing system.

### DETAILED DESCRIPTION

Systems disclosed herein improve upon previous techniques for preventing (or at least reducing) fires caused by flashback in a grill. A flashback may occur when oxygen to fire in a grill has been cut off by closing the lid, followed by the opening of the lid causing an inrush of oxygen to the fire, causing a flareup. By cutting off oxygen to the fire, the fire is starved for oxygen upon consuming the oxygen in the grill. When the lid is opened, oxygen rushes back into the grill, causing a flareup if there is sufficient fuel and heat to cause an ignition. Certain aspects of the present disclosure provide an air intake system that allows oxygen to be supplied to the fire before opening the lid, preventing (or at least reducing) flashback.

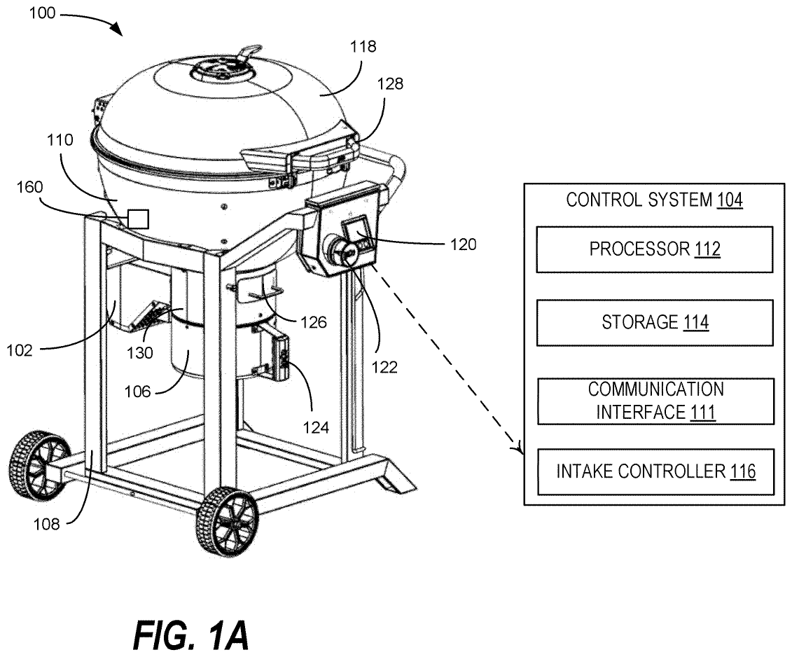

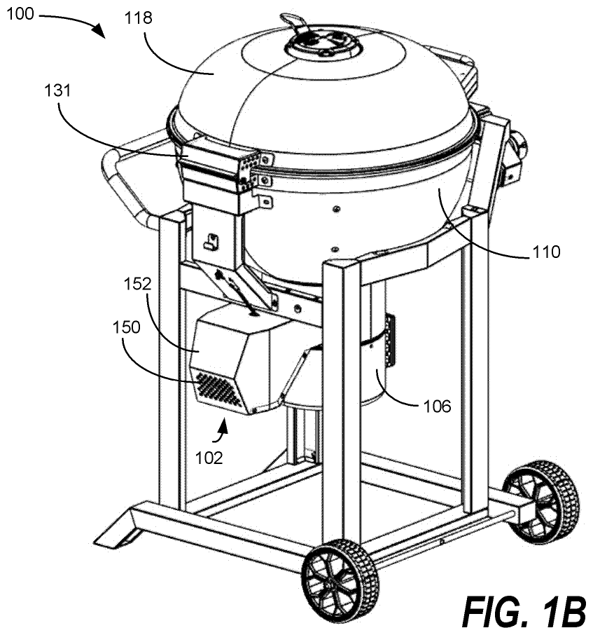

FIGS. 1A and 1B illustrate different perspectives of an example kettle grill 100 including an air intake system 102, in accordance with certain aspects of the present disclosure. As shown, the kettle grill 100 includes a fire bowl 110 (also referred to as a kettle or a body having an interior space for holding flammable material such as briquettes). The fire bowl may hold briquettes for starting and maintaining a fire. The kettle grill may also include a lid 118 including a handle 128 and coupled to the fire bowl 110 via a hinge 131. As shown, the kettle grill 100 is supported by a stand 108. The kettle grill 100 includes an ash cup 106. Ashes from the grill fall into the ash cup 106, which may be removed and emptied via handle 124. The kettle grill 100 also includes a support assembly 130, which may house a starter tray 126. The kettle grill 100 may include a display 120, which may display various settings of the grill, and a control knob 122 for changing the settings.

As shown in FIG. 1B, the air intake system 102 may include openings 150 in housing 152. Housing 152 may house a fan (not shown) that pulls air from the openings 150 into the housing 152 and up to the fire bowl 110. During operation, prior to opening the lid 118, the air intake system 102 may be activated to pull air into fire bowl 110, providing oxygen to the fire. As a result, the fire in the will not be starved of oxygen when opening the lid, preventing (or at least reducing) flashback.

As shown in FIG. 1A, the kettle grill 100 may include a control system 104. The control system 104 may include a processor 112 for controlling the overall operation of the grill 100 and its associated components, including the display 120, control knob 122 and/or storage 114. Software can be stored within storage 114 to provide instructions to processor 112, allowing control system 104 to perform various actions. For example, storage 114 can store software used by the control system to display settings on display 120, receive inputs via control knob 122, and control various operations such as activating the air intake system 102. The various hardware memory units in storage 114 can include volatile and nonvolatile, removable, and non-removable media implemented in any method or technology for storage of information such as computer-readable instructions, data structures, program modules or other data.

In some aspects, the control system 104 may include a communication interface 111 to receive and/or transmit signaling. The signaling may include signals to control the operations of grill 100, such as activating the air intake system 102. Data may also be transmitted via the communication interface, such as whether the intake system 102 is active. In some aspects, the control system 104 includes an intake controller 116. The intake controller 116 may receive an input (e.g., user input received via control knob 122 or wirelessly via communication interface 111), and output an activation signal in response to receiving the input. The activation signal may activate the intake system 102.

In some aspects, the kettle grill 100 may include one or more sensors 160, as shown in FIG. 1A. The one or more sensors 160 may detect a condition within an interior space of the fire bowl. For example, one or more sensors 160 may indicate the fire bowl's temperature and/or oxygen level. In some aspects, the sensor data from the one or more sensors 160 may be used by the control system to determine whether to activate the intake system 102. For example, if the temperature is above a threshold and the oxygen level drops below a threshold, and the lid of the kettle grill 100 is closed, the control system may activate the intake system 102 to prevent flashback.

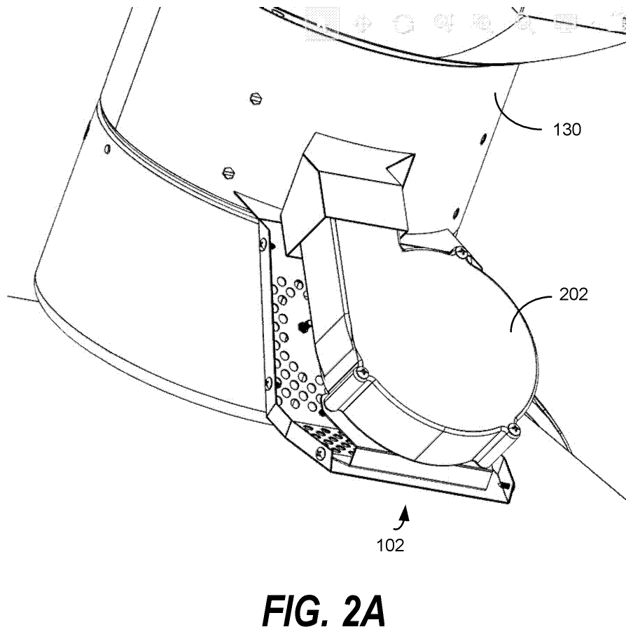

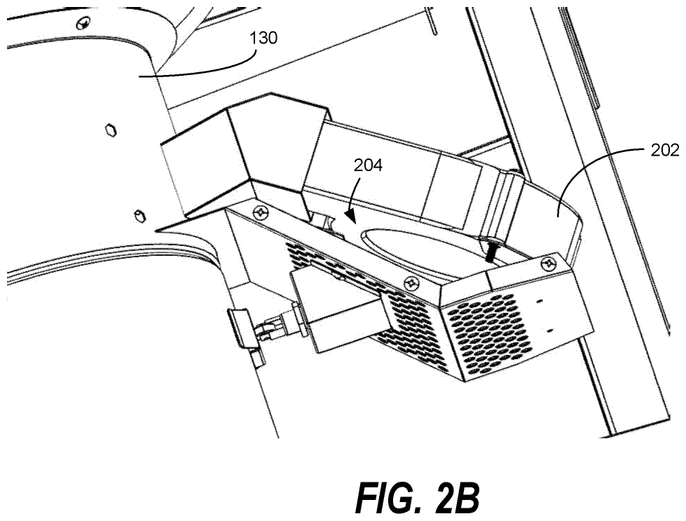

FIGS. 2A and 2B illustrate a fan 202 of the air intake system 102, in accordance with certain aspects of the present disclosure. As shown, the fan 202 may be configured to pull air from the opening 204, shown in FIG. 2B, and provide the air to the support assembly 130 and up to the fire bowl 110, providing oxygen to the fire prior to the lid being opened.

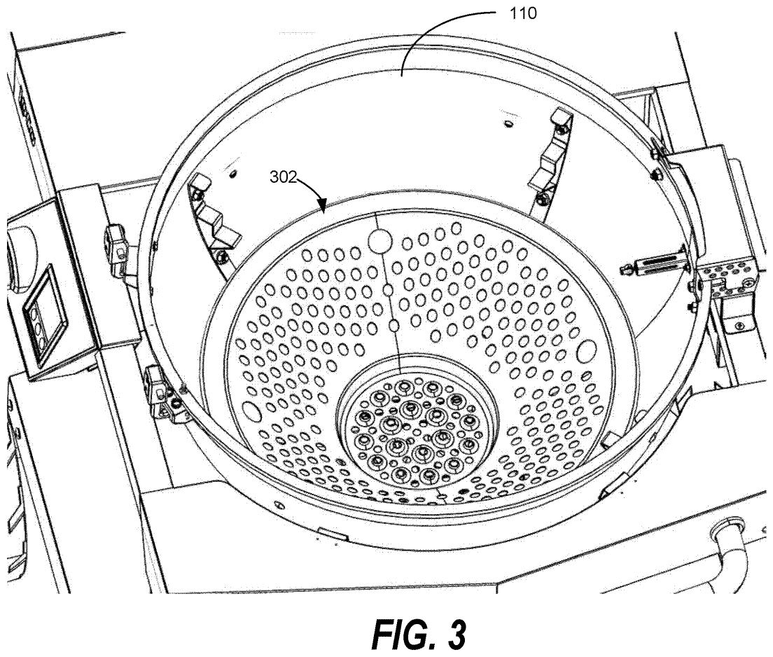

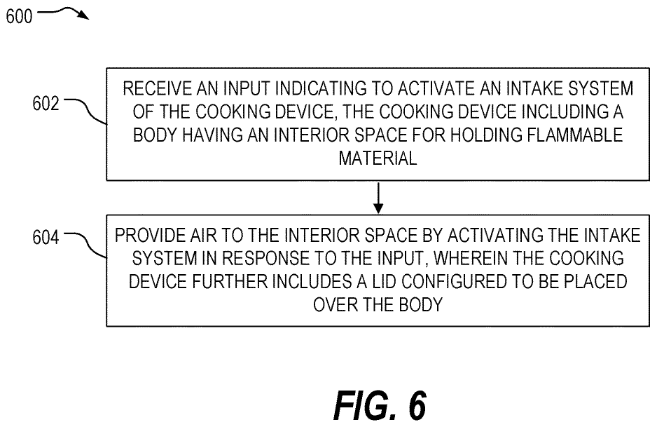

FIG. 3 illustrates the fire bowl 110, in accordance with certain aspects of the present disclosure. As shown, the fire bowl 110 includes openings 302 at the bottom of the fire bowl 110, allowing ashes to fall down to the ash cup 106 described with respect to FIG. 6. The openings 302 also allow air from the air intake system 102 to be provided to the fire in the fire bowl 110, providing oxygen to the fire as described herein.

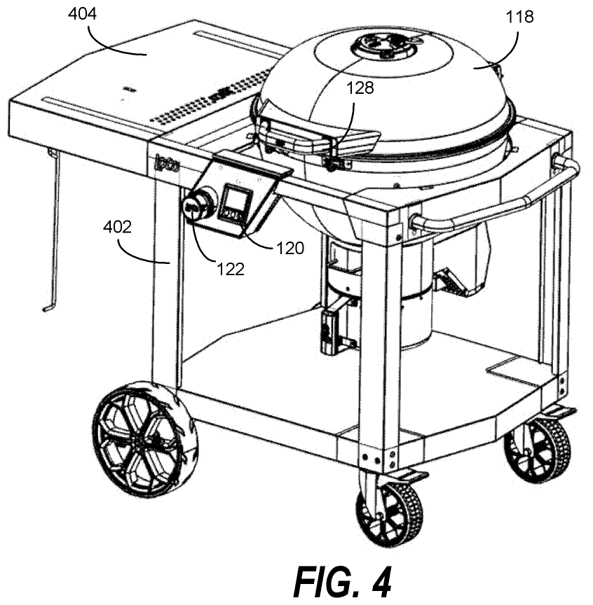

FIG. 4 illustrates the kettle grill 100 with a cart 402, in accordance with certain aspects of the present disclosure. The cart 402 may be coupled to a side shelf 404, as shown. Either the cart 402 shown in FIG. 4, or the stand 108 shown in FIGS. 1A and 1B, may provide support for the kettle grill and include the electronics for the control system 104, the display 120, and the control knob 122.

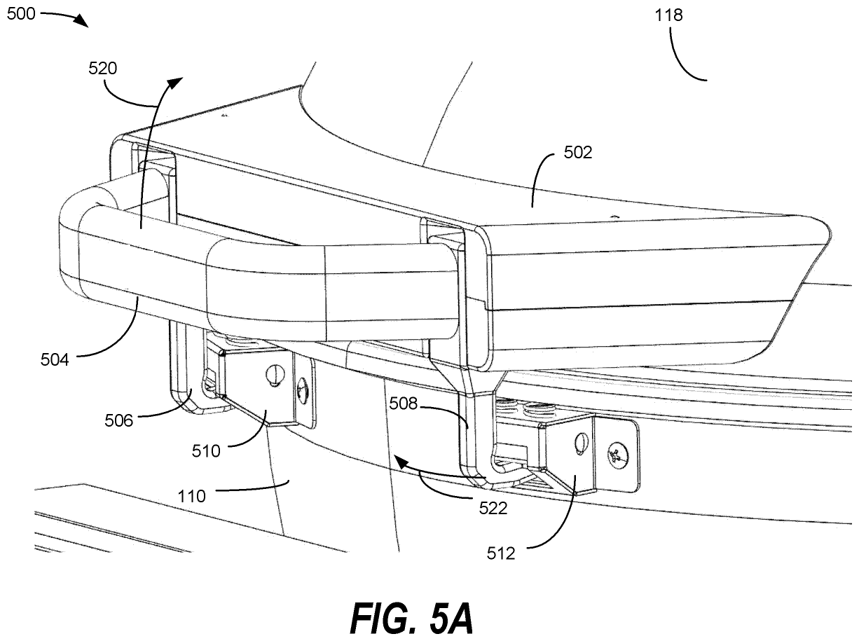

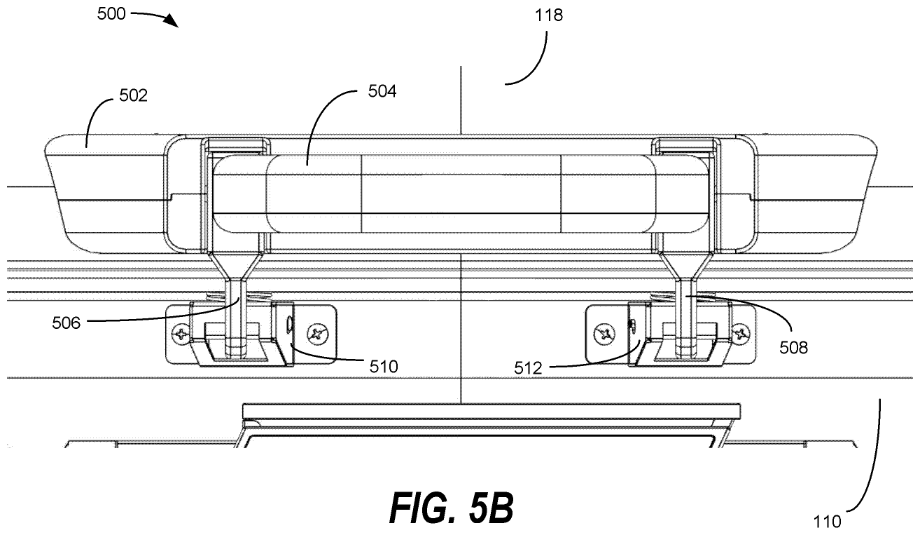

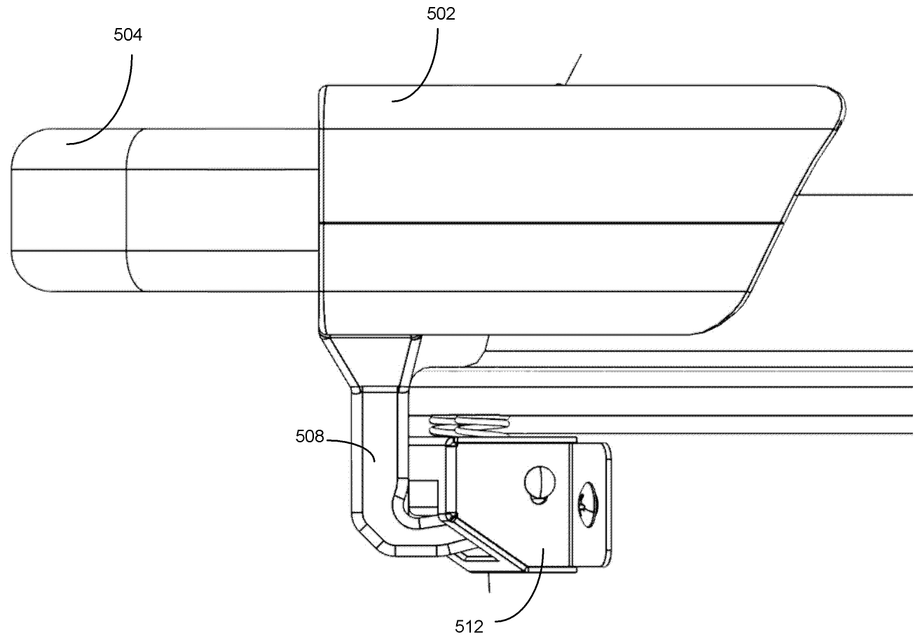

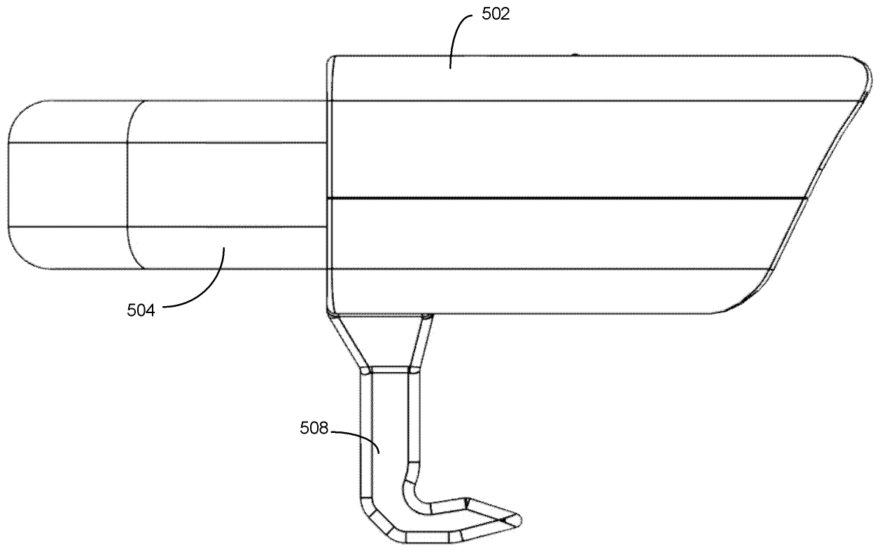

FIGS. 5A, 5B, and 5C illustrate a latch handle 500, in accordance with certain aspects of the present disclosure. FIG. 5A is a perspective view of the latch handle 500. FIG. 5B is a front view of the latch handle 500. FIG. 5C is a side view of the latch handle 500.

The latch handle 500 may correspond to the handle 128 described herein. The latch handle 500 includes a support element 502 coupled to handle portion 504. The handle portion 504 pivots, with respect to the support element 502, in the direction shown by arrow 520. Latch elements 510, 512 are coupled to fire bowl 110. The handle portion 504 is coupled to latch hooks 506, 508 that hook under respective latch elements 510, 512, locking the lid 118 to the fire bowl 110. When the handle portion 504 pivots in the direction shown by arrow 520, the hooks 506, 508 also pivot in direction 522 so that the hooks 506, 508 are no longer locked below the respective latch elements 510, 512, allowing the lid to be raised. FIG. 5D is a side view of the latch handle 500 showing hooks 506, 508.

FIG. 6 illustrates a method 600 for operating a cooking device, in accordance with certain aspects of the present disclosure. The method can be performed by a grill, such as the kettle grill 100 including the control system 104.

At block 602, the grill receives an input indicating to activate an intake system (e.g., intake system 102) of the cooking device. The input may be from a user provided to activate the intake system. In some aspects, the cooking device may include one or more sensors (e.g., one or more sensors 160). The input may include sensor data from the one or more sensors. In some aspects, the grill (e.g., the control system 104) may receive wireless data via a communication interface (e.g., communication interface 111). The input may be based on the wireless data.

In some aspects, the cooking device includes a body (e.g., fire bowl 110) having an interior space for holding flammable material. The intake system may be below the body. The air may be provided to the interior space through openings (e.g., openings 302 shown in FIG. 3) on a bottom surface of the body.

At block 604, the grill provides air to the interior space by activating the intake system in response to the input. The cooking device may further include a lid (e.g., lid 118) configured to be placed over the body. In some aspects, the grill may selectively coupling the lid to the body via one or more latches (e.g., hooks 506, 508 coupling to latch elements 510, 512) coupled to a handle (e.g., handle portion 504), the handle being coupled to the lid. In some aspects, the intake system provides the air to the interior space while the lid is closed. The cooking device may also include a support element (e.g., stand 108 or cart 402) configured to support the body.

It is to be understood that the specific order or hierarchy of operations in the method 600 depicted in FIG. 6 and throughout this disclosure are instances of example approaches and can be rearranged while remaining within the disclosed subject matter. For instance, any of the operations depicted in FIG. 6 and throughout this disclosure can be omitted, repeated, performed in parallel, performed in a different order, and/or combined with any other of the operations depicted in FIG. 6 and throughout this disclosure. Moreover, any of the example systems or methods illustrated in figures, or the components or operations thereof, can be combined together.

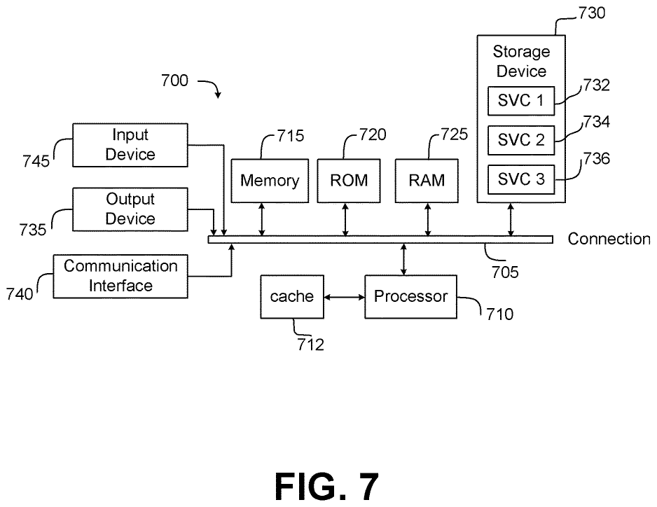

FIG. 7 illustrates an architecture of a computing system 700 wherein the components of the system 700 are in electrical communication with each other using a connection 705, such as a bus. Exemplary system 700 includes a processing unit (CPU or processor) 710 and a system connection 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable client interaction with the computing system 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a client to provide multiple types of input to communicate with the computing system 700. The communications interface 740 can generally govern and manage the client input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

1. A cooking device comprising:
a body having an interior space for holding flammable material;
a lid configured to be placed over the body;
an intake system; and
a control system configured to receive an input and output an activation signal to the intake system based on the input, the intake system being configured to provide air to the interior space in response to the activation signal.

2. The cooking device of claim 1, wherein the input is from a user provided to activate the intake system.

3. (canceled)

4. The cooking device of claim 1, further comprising one or more sensors, and wherein the input comprises sensor data from the one or more sensors.

5. The cooking device of claim 1, further comprising a communication interface configured to receive wireless data, wherein the input is based on the wireless data.

6. The cooking device of claim 1, further comprising:
a handle coupled to the lid; and
a latch coupled to the handle and configured to removably coupled the lid to the body.

7. The cooking device of claim 6, further comprising a latch element coupled to the body, wherein latch hooks below the latch element to couple the lid to the body.

8. The cooking device of claim 7, wherein the handle pivots to unhook the latch from below the latch element.

9. The cooking device of claim 1, wherein the intake system is below the body and configured to provide the air to the interior space through openings on a bottom surface of the body.

10. The cooking device of claim 1, wherein the intake system provides the air to the interior space while the lid is closed.

11. The cooking device of claim 1, further comprising a support element configured to support the body.

12. The cooking device of claim 1, wherein the control system is further configured to determine whether the lid is closed, and wherein the air is provided to the interior space based on the determination.

13. A method for operating a cooking device, comprising:
receiving an input indicating to activate an intake system of the cooking device, the cooking device including a body having an interior space for holding flammable material; and
providing air to the interior space by activating the intake system in response to the input, wherein the cooking device further includes a lid configured to be placed over the body.

14. The method of claim 13, wherein the input is from a user provided to activate the intake system.

15. (canceled)

16. The method of claim 13, wherein the cooking device further comprises one or more sensors, and wherein the input comprises sensor data from the one or more sensors.

17. The method of claim 13, further comprising receiving wireless data via a communication interface, wherein the input is based on the wireless data.

18. The method of claim 13, further comprising selectively coupling the lid to the body via one or more latches coupled to a handle, the handle being coupled to the lid.

19. The method of claim 13, wherein the intake system is below the body, and wherein the air is provided to the interior space through openings on a bottom surface of the body.

20. The method of claim 13, wherein the intake system provides the air to the interior space while the lid is closed.

21. The method of claim 13, wherein the cooking device further comprises a support element configured to support the body.

22. A cooking device comprising:
a body having an interior space for holding flammable material;
a lid configured to be placed over the body; and
an intake system configured to provide air to the interior space in response to an activation signal and while the lid is closed.
